(19) United States
(12) Patent Application Publication
(10) Pub. No.: US 2020/0168012 A1
(43) Pub. Date: May 28, 2020

(54) PERSONAL FUEL EFFICIENCY FOR VEHICLES OF INTEREST

(71) Applicant: International Business Machines Corporation, Armonk, NY (US)

(72) Inventors: Gregory J. Boss, Saginaw, MI (US); Kulvir Singh Bhogal, Fort Worth, TX (US); Rick A. Hamilton, II, Charlottesville, VA (US); Ninad Sathaye, Pune (IN)

(21) Appl. No.: 16/202,962

(22) Filed: Nov. 28, 2018

(51) Int. Cl. G07C 5/08; B60W 40/09; G07C 5/00; F02B 77/08

(52) U.S. Cl. CPC G07C 5/0841; F02B 77/084; G07C 5/008; B60W 40/09

(57) ABSTRACT

A computer-implemented method, system, and program product for providing a personal fuel efficiency for a vehicle of interest to a user. Responsive to receiving an input, a particular vehicle having a number of fuel efficiency attributes is identified. Driver attribute data providing information of personal driving behaviors of the user when driving another vehicle is accessed. The driver attribute data is obtained from a number of sensors on the other vehicle. Using the driver attribute data, a predicted impact on the number of fuel efficiency attributes is determined. The number of fuel efficiency attributes is adjusted based on the predicted impact to determine the personal fuel efficiency. The computer renders the personal fuel efficiency on a user device or on a display device located on the particular vehicle.

### BACKGROUND

### 1. Field

The disclosure relates generally to a system and method for predicting and displaying personal fuel efficiency for a particular vehicle and a particular user before the particular user has driven the particular vehicle.

### 2. Description of the Related Art

When purchasing a new or used vehicle, one important factor buyers may consider is fuel economy. New vehicles display a rating in miles per gallon. However, not all drivers achieve the rating displayed on the car. Achieved fuel economy varies because not all drivers have the same driving habits and skills. Furthermore, not all drivers operate the vehicle in similar weather conditions and road conditions. In order to account for the differences in fuel economy by individual drivers, some currently available services offer a simulation based on input from questions to a user of the service. However, such simulation is dependent on the accuracy with which drivers may answer questions regarding their driving habits and skills.

Therefore, a need exists for a method and system to determine and display more accurately a personal fuel efficiency to be achieved by a user in a particular vehicle of interest to the user, before the user actually drives the particular vehicle of interest.

### SUMMARY

According to one illustrative embodiment, a computer-implemented method for displaying a personal fuel efficiency for a vehicle of interest to a user, the computer-implemented method comprising: responsive to receiving an input, identifying, by a computer, a particular vehicle having a number of fuel efficiency attributes; accessing, by the computer, driver attribute data providing information of personal driving behaviors of the user when driving another vehicle, wherein the driver attribute data is obtained from sensors on the other vehicle; using the driver attribute data, determining by the computer, a predicted impact on the number of fuel efficiency attributes; adjusting, by the computer, the number of fuel efficiency attributes based on the predicted impact to determine the personal fuel efficiency; and rendering, by the computer, the personal fuel efficiency on a user device or on a display device located on the particular vehicle.

A computer system and a computer program product for providing a personal fuel efficiency for a vehicle of interest to a user, are also disclosed.

### BRIEF DESCRIPTION OF THE DRAWINGS

FIG. 1 is a pictorial representation of a network of data processing systems in which illustrative embodiments can be implemented;

FIG. 2 is a diagram of a data processing system in which illustrative embodiments can be implemented;

FIG. 3 is a block diagram of a vehicle parameter database in which illustrative embodiments can be implemented;

FIG. 4 is a block diagram of an attribute database for vehicles and drivers in which illustrative embodiments can be implemented;

FIG. 5 is a block diagram of a system for collecting sensor data in which illustrative embodiments can be implemented;

FIG. 6 is a schematic diagram of a system for determining a predicted impact of personal data on vehicle efficiency for a particular vehicle and a particular driver in accordance with an illustrative embodiment;

FIG. 7 is a block diagram of a data processing system, a user device, and a particular vehicle with a window display and a vehicle pricing sticker in which illustrative embodiments can be implemented;

FIG. 8 is a pictorial representation of a user obtaining a personal fuel efficiency for a particular vehicle of interest using a cellphone, a window display, and a vehicle pricing sticker on the particular vehicle of interest in which illustrative embodiments can be implemented;

FIG. 9 is a flowchart illustrating a process for determining and displaying a personal fuel efficiency for a particular vehicle of interest to a user in accordance with an illustrative embodiment;

FIG. 10 is a flowchart illustrating a process for determining a personal fuel efficiency for a particular vehicle and a particular user in accordance with an illustrative embodiment;

FIG. 11 is a flowchart illustrating a process for determining a personal fuel efficiency in accordance with an illustrative embodiment;

FIG. 12 is a flowchart illustrating a process for displaying a personal fuel efficiency in accordance with an illustrative embodiment;

FIG. 13 is a flowchart illustrating a process for using a personal fuel efficiency to determine a recommendation in accordance with an illustrative embodiment; and

FIG. 14 is a flowchart illustrating a process for using a personal fuel efficiency to determine a new driving behavior in accordance with an illustrative embodiment.

### DETAILED DESCRIPTION

The illustrative embodiments recognize and take into account that a vehicle manufacturer can install sensors in a vehicle and that these sensors, as well as additional sensors that can be installed may provide data.

The illustrative embodiments recognize and take into account that crowdsourced information such as condition of vehicles of a similar make and model to a particular vehicle in a given region can provide additional information. Such additional information can add to data based on non-crowdsourced information.

The illustrative embodiments recognize and take into account that driving habits of a particular driver can affect fuel efficiency of a vehicle. The differences in mileage achieved by different drivers can be due to the driving habits of individuals as well as road conditions, preferred routes typically traveled, and weather conditions encountered by drivers in their respective regions.

The illustrative embodiments recognize and take into account that sensors installed in vehicles can capture data for the driving habits of particular drivers as well as capture data on the road conditions, the preferred routes typically traveled, and the weather conditions encountered.

The illustrative embodiments recognize and take into account that a first user and a second user can identify a particular vehicle of interest. From the first user's driving habits, skills, and common vehicle routes, a data processing system can learn that a first user tends to accelerate quickly, tends to brake quickly, and drives in city traffic. From the second user's driving habits, skills, and common vehicle routes, the data processing system can learn that the second user accelerates gradually and frequently drives on a freeway. The data processing system can predict personal fuel efficiency for the same particular vehicle of interest for the first user and the second user. The personal fuel efficiency can be expressed as a value representing an expected miles per gallon (mpg). In one illustrative embodiment, the first user's personal fuel efficiency for the particular vehicle of interest can be forty-one (41) miles per gallon, and the second user's personal fuel efficiency for the same particular vehicle of interest can be forty-five (45) miles per gallon. The difference can be accounted for by the data processing system taking into account each user's driving habits, skills, and common vehicle routes in providing personal fuel efficiency to each user.

The illustrative embodiments recognize and take into account that surface transport logistics providers can benefit from a system that provides data and recommendations on pairing particular drivers with particular vehicles in order to improve efficiency and fuel economy of a fleet of vehicles.

The illustrative embodiments recognize and take into account that a system can be cloud-based either in whole or in part. As used herein, cloud-based storage can comprise remote servers accessed from the Internet.

The illustrative embodiments recognize and take into account that one or more vehicle manufacturers can offer a service that provides an application downloadable to a user device for providing an input to a data processing system. The input may be one or more of a keyboard entry, a touchscreen entry, and a scanned barcode.

The present invention may be a system, a method, and/or a computer program product at any possible technical detail level of integration. The computer program product can include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically-encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

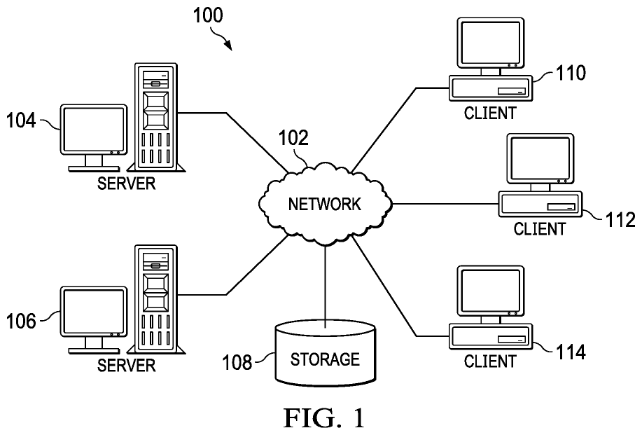

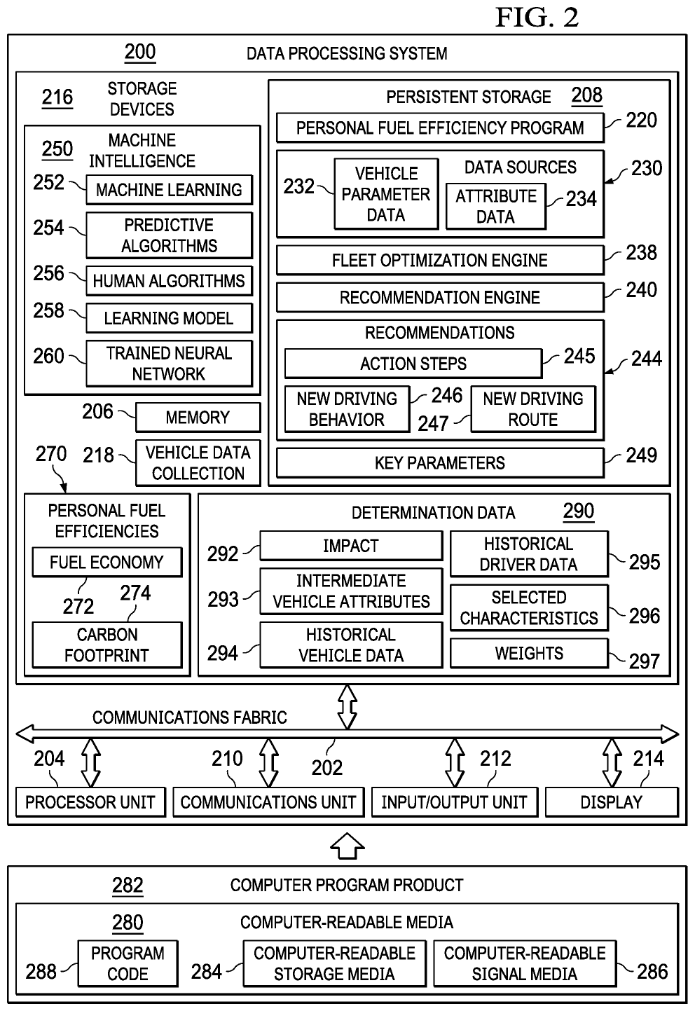

With reference now to the figures and, in particular, with reference to FIG. 1 and FIG. 2, diagrams of data processing environments are provided in which illustrative embodiments can be implemented. It should be appreciated that FIG. 1 and FIG. 2 are only meant as examples and are not intended to assert or imply any limitation with regard to the environments in which different embodiments can be implemented. Many modifications to the depicted environments can be made.

FIG. 1 depicts a pictorial representation of a network of data processing systems in which illustrative embodiments can be implemented. Network data processing system 100 is a network of computers, data processing systems, and other devices in which the illustrative embodiments can be implemented. Network data processing system 100 contains network 102, which is the medium used to provide communications links between the computers, data processing systems, and other devices connected together within network data processing system 100. Network 102 can include connections. The connections may be, for example, wire communication links, wireless communication links, and fiber optic cables.

In the depicted example, server 104 and server 106 connect to network 102, along with storage 108. Server 104 and server 106 can be, for example, computers with high-speed connections to network 102. In addition, server 104 and server 106 can provide fuel efficiency prediction services. For example, server 104 and server 106 can automatically predict a personal fuel efficiency in a particular vehicle of interest to a user. Further, it should be noted that server 104 and server 106 can each represent a cluster of computers in a data center hosting a plurality of services for predicting a personal fuel efficiency in a particular vehicle of interest to a user. Alternatively, server 104 and server 106 can represent computer nodes in a cloud environment that predict personal fuel efficiencies for users in particular vehicles of interest to the users.

Client 110, client 112, and client 114 also connect to network 102. Clients 110, 112, and 114 are clients of server 104 and server 106. In this example, clients 110, 112, and 114 are illustrated as desktop or personal computers with wire communication links to network 102. However, it should be noted that clients 110, 112, and 114 are meant as examples only. In other words, clients 110, 112, and 114 can include other types of data processing systems. The other types of data processing systems may be network computers, laptop computers, handheld computers, smart phones, smart watches, smart televisions, and the like, with wire or wireless communication links to network 102. Users of clients 110, 112, and 114 can utilize clients 110, 112, and 114 to access the activity consequence prediction services provided by server 104 and server 106.

Storage 108 is a network storage device capable of storing any type of data in a structured format or an unstructured format. In addition, storage 108 can represent a plurality of network storage devices. Further, storage 108 can store, for example, vehicle data collection 218, personal fuel efficiency program 220, data sources 230, fleet optimization engine 238, recommendation engine 240, recommendations 244, key parameters 249, machine intelligence 250, personal fuel efficiencies 270, and determination data 290 as shown in FIG. 2. Furthermore, storage 108 can store other types of data, such as authentication or credential data that can include user names, passwords, and biometric data associated with client device users and system administrators, for example.

In addition, it should be noted that network data processing system 100 can include any number of additional servers, clients, storage devices, and other devices not shown. Program code located in network data processing system 100 can be stored on a computer-readable storage medium and downloaded to a computer or other data processing device for use. For example, the program code can be stored on a computer-readable storage medium on server 104 and downloaded to client 110 over network 102 for use on client 110.

In the depicted example, network data processing system 100 can be implemented as a number of different types of communication networks, such as, for example, an internet, an intranet, a local area network (LAN), a wide area network (WAN), or any combination thereof. FIG. 1 is intended as an example only, and not as an architectural limitation for the different illustrative embodiments.

With reference now to FIG. 2, a diagram of a data processing system is depicted in which illustrative embodiments can be implemented. Data processing system 200 is an example of a computer, such as server 104 in FIG. 1, in which computer-readable program code or instructions implementing processes of illustrative embodiments can be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that can be loaded into memory 206. Processor unit 204 can be a set of one or more hardware processor devices or can be a multi-processor core, depending on the particular implementation.

Memory 206 and persistent storage 208 are examples of storage devices 216. A computer-readable storage device is any piece of hardware that is capable of storing information, such as, for example, without limitation, data, computer-readable program code in functional form, and/or other suitable information either on a transient basis and/or a persistent basis. Further, a computer-readable storage device excludes a propagation medium. Memory 206, in these examples, can be, for example, a random-access memory, or any other suitable volatile or non-volatile storage device. Persistent storage 208 can take various forms, depending on the particular implementation. For example, persistent storage 208 can contain one or more devices. For example, persistent storage 208 may be a hard drive, a flash memory, a rewritable optical disk, a rewritable magnetic tape, or some combination of the above. The media used by persistent storage 208 can be removable. For example, a removable hard drive can be used for persistent storage 208.

In this illustrative embodiment, persistent storage 208 stores personal fuel efficiency program 220. However, it should be noted that even though personal fuel efficiency program 220 is illustrated as residing in persistent storage 208, in an alternative illustrative embodiment, personal fuel efficiency program 220 can be a separate component of data processing system 200. For example, in an alternative illustrative embodiment, personal fuel efficiency program 220 can be a hardware component coupled to communications fabric 202 or a combination of hardware and software components.

Personal fuel efficiency program 220 controls the process for providing personal fuel efficiency for a vehicle of interest to a user. Personal fuel efficiency program 220 utilizes data sources 230 to collect vehicle parameter data 232 and attribute data 234. Personal fuel efficiency program 220 can use fleet optimization engine 238, recommendation engine 240, and machine intelligence 250. Fleet optimization engine 238, recommendation engine 240, and machine intelligence 250 can be applications configured to work with personal fuel efficiency program 220.

Fleet optimization engine 238 can use a personal fuel efficiency determined by personal fuel efficiency program 220 to determine a new driving behavior. Fleet optimization engine 238 can perform process 1400 shown in FIG. 14. Recommendation engine 240 can use a personal fuel efficiency determined by personal fuel efficiency program 220 to determine one or more of recommendations 244 such as action steps 245, new driving behavior 246, and new driving route 247.

Machine intelligence 250 comprises machine learning 252, predictive algorithms 254, human algorithms 256, learning model 258, and trained neural network 260. Machine intelligence 250 can be implemented using a neural network. The neural network can be trained neural network 260. Machine intelligence 250 may also be implemented using an artificial intelligence system, a Bayesian network, an expert system, a fuzzy logic system, a genetic algorithm, and other types of systems. Machine intelligence 250 can make recommendations on selection of algorithms such as predictive algorithms 254 and human algorithms 256. Moreover, machine intelligence 250 can analyze data from a number of databases such as attribute data 234 and vehicle parameter data 232 to select from the algorithms. Machine intelligence 250 can train itself to identify behavior of individual drivers and driving habits of the individual drivers from sensor data. Machine learning 252 can be integrated with personal fuel efficiency program 220.

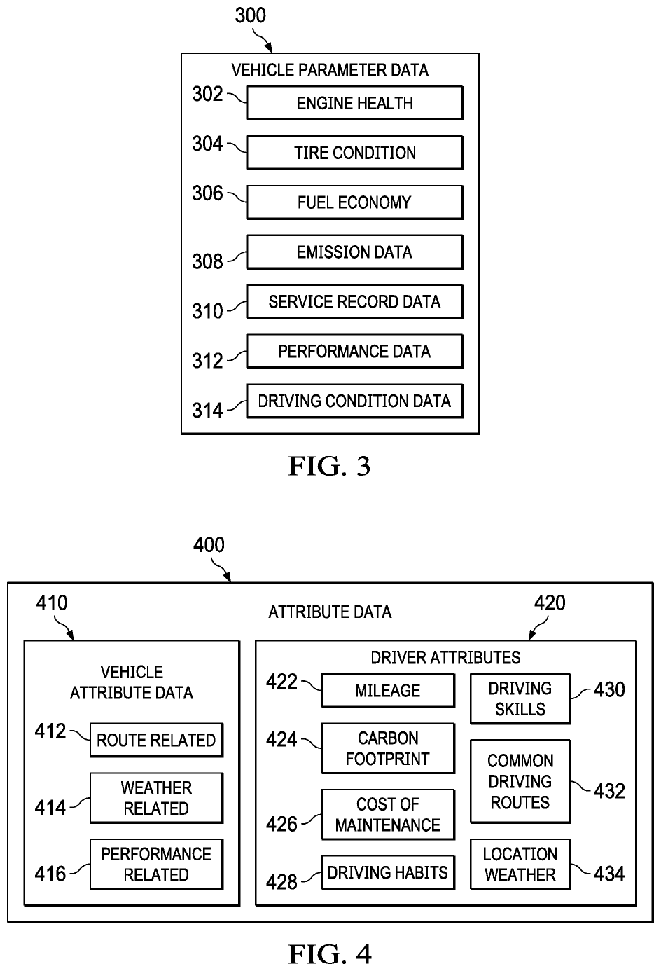

Personal fuel efficiency program 220 can select weights in weights 297. Weights 297 can be assigned to parameters in vehicle parameter data 232 and attribute data 234. Weights 297 can be assigned to parameters in vehicle parameter data 300 in FIG. 3 and attribute data 400 in FIG. 4. Further, personal fuel efficiency program 220 can assign weights in weights 297 to one or more of impact 292, intermediate vehicle attributes 293, selected characteristics 296, historical vehicle data 294, and historical driver data 295. For example, in an illustrative embodiment, weight can be given to a number of most recent events so that historical driver data 295 for a driver who has moved to an area where a commute is made at peak hours would be more accurate than older historical driver data where the driver did not have a commute in heavy traffic. The illustrative embodiments recognize and take into account that determinations using determination data 290 can be made by placing appropriate weights, such as weights 297, on each of vehicle parameter data 232 and attribute data 234. The illustrative embodiments recognize and take into account that determinations using determination data 290 can be made by placing appropriate weights, such as weights 297, on vehicle parameter data 232, attribute data 234, attribute data 400 in FIG. 4, and driver attributes 420 in FIG. 4 in order to increase accuracy of a predicted fuel economy or carbon footprint.

In addition, personal fuel efficiency program 220 extracts vehicle parameter data 232 and attribute data 234 from vehicle data collection 218. Personal fuel efficiency program 220 determines recommendations 244, which can be new driving behavior 246, new driving route 247, and one or more of action steps 245 to improve performance for a particular vehicle and a particular driver. Personal fuel efficiency program 220 can determine key parameters 249. Personal fuel efficiency program 220 can use determination data 290 to determine key parameters 249.

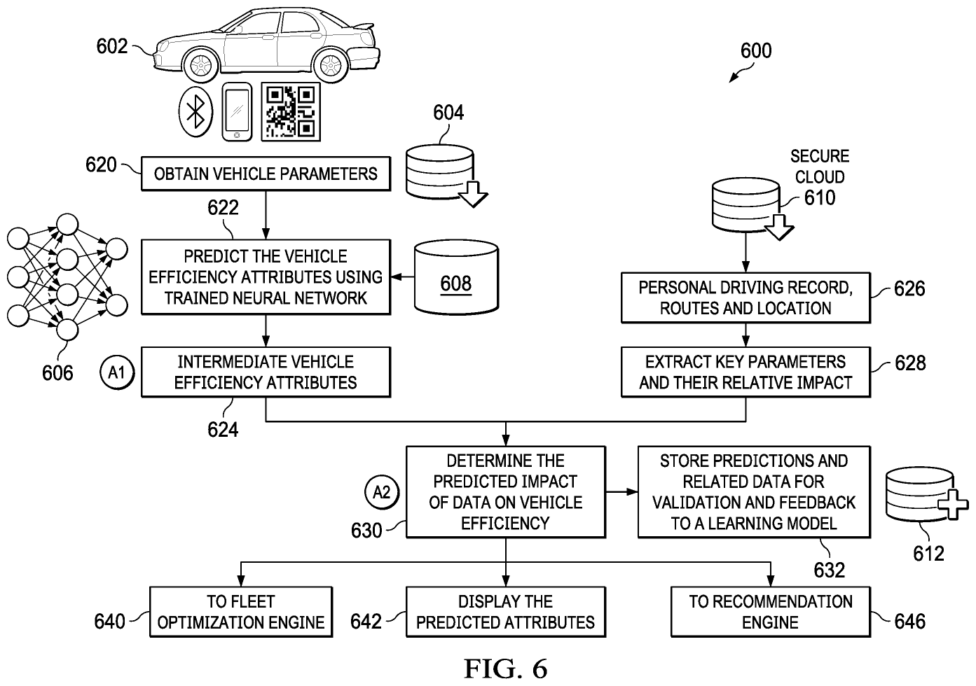

Determination data 290 can comprise impact 292, intermediate vehicle attributes 293, historical vehicle data 294, historical driver data 295, selected characteristics 296, and weights 297. Impact 292 can comprise a value that quantitatively indicates a deviation from a vehicle's stated performance data, such as a rating for fuel consumption in miles per gallon caused by one or more key parameters such as key parameters 249 in FIG. 2. As used herein, key parameters are values representing a particular driver behavior that results in a deviation from a vehicle's stated performance data, such as a rating for fuel consumption in miles per gallon. Intermediate vehicle attributes 293 can be predicted parameter attributes based on data from a database such as database 608 in FIG. 6. Predicted parameter attributes can be determined by neural network 606 in FIG. 6 and by machine intelligence 250. Historical vehicle data 294 can be a summary of data for a particular vehicle based on vehicle attribute data 410 in FIG. 4. Historical driver data 295 can be a summary of data for a particular driver based on driver attributes 420 in FIG. 4. Selected characteristics 296 can be attributes selected for determinations by personal fuel efficiency program 220 in FIG. 2. Recommendation engine 240 can determine recommendations 244. Recommendations 244 can comprise actions steps 245, new driving behavior 246, and new driving routes 247. Personal fuel efficiency program 220 can determine and store one or more personal fuel efficiencies in personal fuel efficiencies 270. Personal fuel efficiencies 270 can comprise fuel economy 272 and carbon footprint 274. Fuel economy 272 can be a value representing a relationship between a distance traveled and an amount of fuel consumed. Fuel economy 272 can be expressed as fixed units of fuel per fixed distance and units of distance per fixed fuel unit. Fuel economy 272 can be expressed in miles per gallon. Carbon footprint 274 can be a value representing total emissions caused by a particular vehicle. Carbon footprint 274 can be expressed as a carbon dioxide equivalent. In an illustrative example, carbon footprint 274 can be expressed in an amount of carbon dioxide and other carbon compounds produced in the consumption of a gallon of gasoline by a particular vehicle.

Communications unit 210, in this example, provides for communication with other computers, data processing systems, and devices via a network, such as network 102 in FIG. 1. Communications unit 210 can provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra-high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that can be connected to data processing system 200. For example, input/output unit 212 can provide a connection for user input through a microphone, a keypad, a keyboard, a mouse, and/or some other suitable input device. Display 214 provides a mechanism to display information to a user and can include touch screen capabilities to allow the user to make on-screen selections through user interfaces or input data, for example.

Instructions for the operating system, applications, and/or programs can be located in storage devices 216, which are in communication with processor unit 204 through communications fabric 202. In this illustrative example, the instructions are in a functional form on persistent storage 208. These instructions can be loaded into memory 206 for running by processor unit 204. The processes of the different embodiments can be performed by processor unit 204 using computer-implemented instructions, which can be located in a memory, such as memory 206. These program instructions are referred to as program code, computer-usable program code, or computer-readable program code that can be read and run by a processor in processor unit 204. The program instructions in the different embodiments can be embodied on different physical computer-readable storage devices, such as memory 206 or persistent storage 208.

Program code 288 is located in a functional form on computer-readable media 280 that is selectively removable and can be loaded onto or transferred to data processing system 200 for running by processor unit 204. Program code 288 and computer-readable media 280 form computer program product 282. In one example, computer-readable media 280 can be computer-readable storage media 284 or computer-readable signal media 286. Computer-readable storage media 284 can include, for example, an optical or magnetic disc that is inserted or placed into a drive or other device that is part of persistent storage 208 for transfer onto a storage device, such as a hard drive, that is part of persistent storage 208. Computer-readable storage media 284 also can take the form of a persistent storage, such as a hard drive, a thumb drive, or a flash memory that is connected to data processing system 200. In some instances, computer-readable storage media 284 cannot be removable from data processing system 200.

Alternatively, program code 288 can be transferred to data processing system 200 using computer-readable signal media 286. Computer-readable signal media 286 can be, for example, a propagated data signal containing program code 288. For example, computer-readable signal media 286 may be an electro-magnetic signal, an optical signal, and/or any other suitable type of signal. These signals can be transmitted over communication links, such as wireless communication links, an optical fiber cable, a coaxial cable, a wire, and/or any other suitable type of communications link. In other words, the communications link and/or the connection can be physical or wireless in the illustrative examples. The computer-readable media also can take the form of non-tangible media, such as communication links or wireless transmissions containing the program code.

In some illustrative embodiments, program code 288 can be downloaded over a network to persistent storage 208 from another device or data processing system through computer-readable signal media 286 for use within data processing system 200. For instance, program code stored in a computer-readable storage media in a data processing system can be downloaded over a network from the data processing system to data processing system 200. The data processing system providing program code 288 may be a server computer, a client computer, or some other device capable of storing and transmitting program code 288.

The different components illustrated for data processing system 200 are not meant to provide architectural limitations to the manner in which different embodiments can be implemented. The different illustrative embodiments can be implemented in a data processing system including components in addition to, or in place of, those illustrated for data processing system 200. Other components shown in FIG. 2 can be varied from the illustrative examples shown. The different embodiments can be implemented using any hardware device or system capable of executing program code. As one example, data processing system 200 can include organic components integrated with inorganic components and/or can be comprised entirely of organic components excluding a human being. For example, a storage device can be comprised of an organic semiconductor.

As another example, a computer-readable storage device in data processing system 200 is any hardware apparatus that can store data. Memory 206, persistent storage 208, and computer-readable storage media 284 are examples of physical storage devices in a tangible form.

In another example, a bus system can be used to implement communications fabric 202 and can be comprised of one or more buses, such as a system bus or an input/output bus. Of course, the bus system can be implemented using any suitable type of architecture that provides for a transfer of data between different components or devices attached to the bus system. Additionally, a communications unit, such as communications unit 210, can include one or more devices used to transmit and receive data, such as a modem or a network adapter. Further, a memory can be, for example, memory 206 or a cache such as found in an interface and memory controller hub that can be present in communications fabric 202.

As a result, illustrative embodiments provide a technical effect of predicting and displaying, for a user, a personal fuel efficiency for a particular vehicle before the user has actually driven the particular vehicle. The personal fuel efficiency can be determined by using data received from vehicle sensors and driver sensors. The personal fuel efficiency can be used to determine a new driving behavior, a new driving route, and one or more action steps to improve performance for a particular vehicle and a particular driver. The personal fuel efficiency can be expressed in miles per gallon or a carbon footprint expressed in an amount of carbon dioxide and other carbon compounds emitted per gallon of fuel consumed.

In addition, the illustrative embodiments provide a technical solution to a technical problem by determining attributes that affect vehicle efficiency when a particular driver is paired with a particular vehicle. The attributes that affect vehicle efficiency when the particular driver is paired with the particular vehicle can be determined using data from driver sensors in vehicles driven by the particular driver that are vehicles other than the particular vehicle. A personal fuel efficiency can be used to determine an efficient pairing of the particular driver with the particular vehicle, so that together, an improved overall fuel efficiency for the driver and vehicle combination can be achieved.

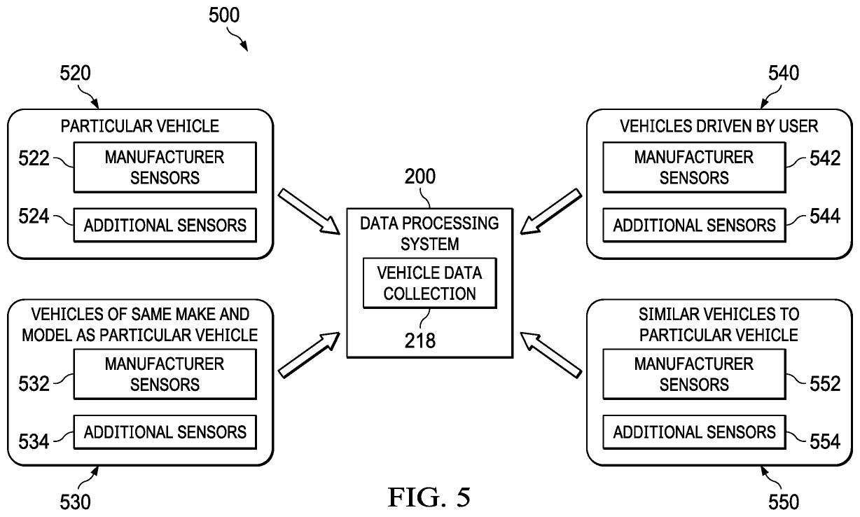

With reference now to FIG. 3, a block diagram of vehicle parameter data is shown in which illustrative embodiments can be implemented. Vehicle parameter data 300 can comprise engine health 302, tire condition 304, fuel economy 306, emission data 308, service record data 310, performance data 312, and driving condition data 314. Vehicle parameter data 300 can be data from a number of internal sensors in a vehicle such as vehicle 602 in FIG. 6. Moreover, vehicle parameter data 300 can be data from internal sensors provided by a manufacturer of a vehicle such as vehicle 602. In an illustrative embodiment, internal sensors can be manufacturer sensors 522, manufacturer sensors 532, manufacturer sensors 542, and manufacturer sensors 552 in FIG. 5. Because vehicle parameter data 300 is provided from sensors supplied by a manufacturer of a vehicle, vehicle parameter data 300 can be normalized for vehicles of a same make and model.

With reference now to FIG. 4, a block diagram of attribute data is shown in which illustrative embodiments can be implemented. Attribute data 400 comprises vehicle attribute data 410 and driver attributes 420. Attribute data 400 can be provided by additional sensors incorporated into a vehicle such as vehicle 602 in FIG. 6. Additional sensors can be added to a vehicle such as vehicle 602 at any point in a lifespan of vehicle 602 provided that the sensors in vehicle 602 are configured for sending data to data processing system 200 in FIG. 2. In an illustrative embodiment, the additional sensors can be additional sensors 524, additional sensors 534, additional sensors 544, and additional sensors 554 in FIG. 5. Since the additional sensors are configured for sending data to data processing system 200, vehicle attribute data 410 and driver attributes 420 can be provided in values that are normalized for processing by personal fuel efficiency program 220 in FIG. 2 and for inclusion in determination data 290 for determinations by personal fuel efficiency program 220 in FIG. 2. Vehicle attribute data 410 can comprise route related 412, weather related 414, and performance related 416. As used herein, route related 412 can be values from one or more additional sensors in a vehicle that indicate a change in a performance parameter of the vehicle due to one or more routes on which the vehicle has been driven. As used herein, weather related 414 can be values from one or more additional sensors in a vehicle that indicate a change in a performance parameter of the vehicle due to one or more weather conditions in which the vehicle has been driven. As used herein, performance related 416 can be values from one or more additional sensors in a vehicle that indicate a change in a performance parameter of the vehicle due to one or more performance related attributes that can be configured to take into account conditions other than route and weather. Driver attributes 420 can comprise a number of attributes. In an illustrative embodiment, driver attributes 420 can include mileage 422, carbon footprint 424, and cost of maintenance 426. In an illustrative embodiment, driver attributes 420 can further include driving habits 428, driving skills 430, common driving routes 432, and location weather 434. Driver attributes 420 can provide data that takes into account particular behaviors, habits, and driving techniques of a particular driver that can cause a change in a performance parameter of a vehicle when the vehicle or a vehicle of similar make and model is driven by the particular driver.

With reference now to FIG. 5, a block diagram of a system for collecting sensor data is depicted in which illustrative embodiments can be implemented. Vehicle data collection system 500 can collect data from a number of sensors in a number of vehicles as described herein. Particular vehicle 520 can obtain data from manufacturer sensors 522 and additional sensors 524. Particular vehicle 520 can transmit data from manufacturer sensors 522 and additional sensors 524 to data processing system 200. Vehicles of same make and model as particular vehicle 530 can obtain data from manufacturer sensors 532 and additional sensors 534. Vehicles of same make and model as particular vehicle 530 can transmit data from manufacturer sensors 532 and additional sensors 534 to data processing system 200. Vehicles driven by user 540 can obtain data from manufacturer sensors 542 and additional sensors 544. Vehicles driven by user 540 can transmit data from manufacturer sensors 542 and additional sensors 544 to data processing system 200. Similar vehicles to particular vehicle 550 can obtain data from manufacturer sensors 552 and additional sensors 554. Similar vehicles to particular vehicle 550 can transmit data from manufacturer sensors 552 and additional sensors 554 to data processing system 200.

In one or more embodiments, owners of particular vehicle 520, vehicles of same make and model as particular vehicle 530, vehicles driven by user 540, and similar vehicles to particular vehicle 550 can elect to opt-in to vehicle data collection 218 of data processing system 200. Alternatively, the owners can elect not to participate in vehicle data collection 218 of data processing system 200. When the owners elect to opt-in to vehicle data collection 218 of data processing system 200, the owners can be informed of what data is to be collected in regard to driving data from their vehicles and how the data will be used. Data from particular vehicle 520, vehicles of same make and model as particular vehicle 530, vehicles driven by user 540, and similar vehicles to particular vehicle 550 can be encrypted. Moreover, the owners of the vehicles from which data is to be collected can be informed that any collected personal data can be encrypted while being used. Furthermore, the owners of the vehicles can opt-out at any time. In the event that an owner opts out, any personal data of the owner that has been collected by vehicle data collection 218 can be deleted from vehicle data collection system 218 as well as any locations where such data could have been stored. As used herein, an owner can be a number of individual owners such as one or more persons, and an owner can be a business entity that can own one or more vehicles for one or more business purposes.

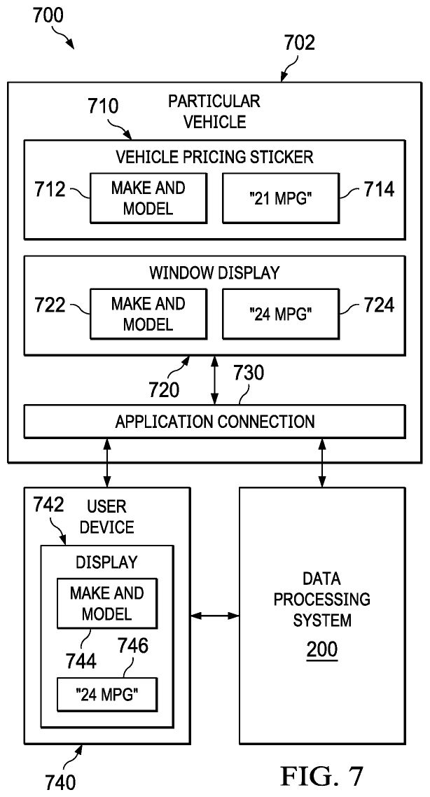

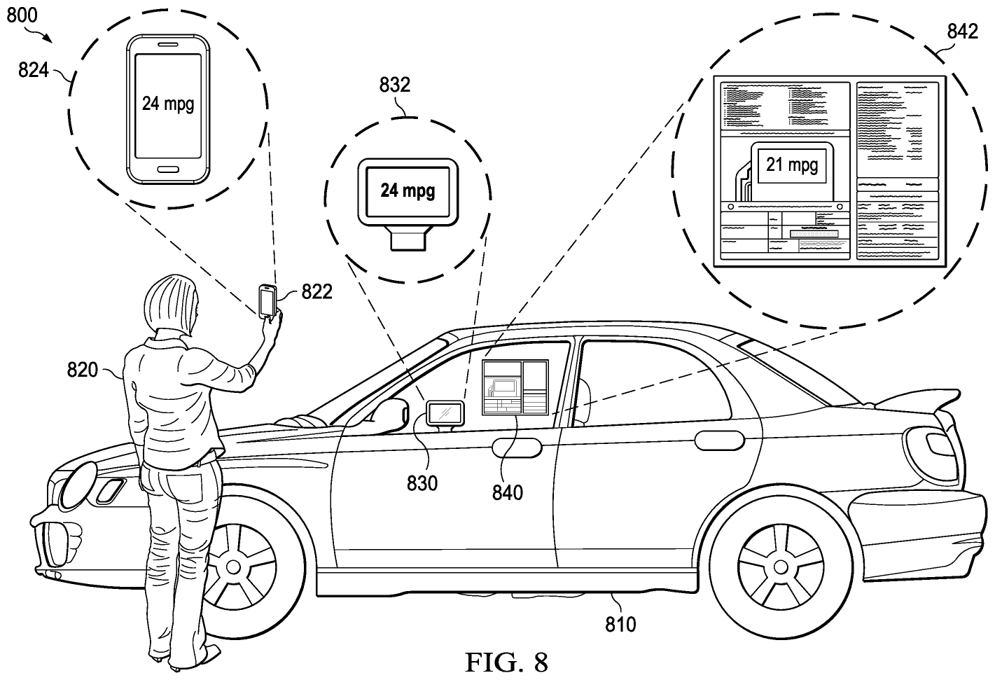

With reference now to FIG. 6, a schematic diagram of a system for determining a predicted impact of personal data on vehicle efficiency for a particular vehicle and a particular driver is depicted in accordance with an illustrative embodiment. System 600 can collect data from a number of databases such as database 604, database 608, and database 612. Database 604 can collect data from a vehicle such as vehicle 602. Data from vehicle 602 can correspond to vehicle parameter data 232 in FIG. 2 and vehicle parameter data 300 in FIG. 3. Vehicle 602 can be particular vehicle 520 in FIG. 5, particular vehicle 702 in FIG. 7, or vehicle of interest 810 in FIG. 8.

Vehicle 602 can provide data from a number of sensors. Sensors can be provided by a manufacturer of a vehicle. In an illustrative embodiment, the sensors can be manufacturer sensors 522, manufacturer sensors 532, manufacturer sensors 542, and manufacturer sensors 552 in FIG. 5. Additional sensors can be incorporated into vehicle 602 at any point in a lifespan of vehicle 602 provided that sensors in vehicle 602 are configured for sending data to data processing system 200 in FIG. 2. In an illustrative embodiment, the additional sensors can be additional sensors 524, additional sensors 534, additional sensors 544, and additional sensors 554 in FIG. 5. Database 604 can ingest data from sensors comprising engine health, tire condition, fuel economy, emission rating, service records, historic data on car performance, and driving condition records stored as engine health 302, tire condition 304, fuel economy 306, emission data 308, service record data 310, performance data 312, and driving condition data 314 in FIG. 3.

Database 608 can correspond to vehicle attribute data 224 in FIG. 2 and vehicle attribute data 410 in FIG. 4. Database 608 can comprise information on similar vehicles to vehicle 602. Similar vehicles can be similar vehicles to particular vehicle 550 in FIG. 5. In an additional embodiment, database 608 can be augmented with crowdsourcing. Crowdsourcing can obtain data in regard to a number of vehicles from a number of persons via the Internet. The number of persons may be paid or unpaid. Crowdsourcing, as used herein, can be a type of participative online activity in which an entity proposes to a number of participants on the Internet to undertake a task. In an illustrative embodiment, the task undertaken can be to provide data regarding a number of vehicles of certain makes and models. In the illustrative embodiment, participants can have sensors configured for transmission of historical vehicle data and historical driver data placed in their vehicles.

Database 608 can comprise attributes such as route related 412, weather related 414, and performance related 416 in FIG. 4. Data from database 610 can correspond to driver attributes 420 in attribute data 400 in FIG. 4. Database 610 can receive data from sensors in a vehicle driven by a particular driver comprising driving habits, skills, common vehicle routes, and location weather. Sensors can be manufacturer sensors 542 and additional sensors 544 in vehicles driven by user 540 in FIG. 5. Database 610 can be a secure cloud-based database.

Personal fuel efficiency program 220 in FIG. 2 can perform steps in system 600 as follows. Personal fuel efficiency program 220 can obtain vehicle parameters (step 620). Personal fuel efficiency program 220 can use neural network 606 and data from database 608 to predict the vehicle efficiency attributes for vehicle 602 (step 622). In an illustrative embodiment, machine intelligence 250 in FIG. 2 can be used to predict the vehicle efficiency attributes. Neural network 606 can be trained neural network 260 in FIG. 2. The predicted parameter attributes are intermediate vehicle efficiency attributes (step 624). Intermediate vehicle efficiency attributes of step 624 can be intermediate vehicle attributes 293 in FIG. 2. Personal fuel efficiency program 220 can obtain personal driving record, routes, and location from database 610 (step 626). Personal fuel efficiency program 220 can extract key parameters and a relative impact of the key parameters (step 628). Key parameters can be key parameters 249 in FIG. 2. The relative impact can be impact 292 in FIG. 2. Illustrative examples of key parameters can be data showing that a particular driver accelerates faster than an average driver and that the particular driver brakes harder than other drivers. Personal fuel efficiency program 220 can use the intermediate parameter attributes, the extracted key parameters, and a relative impact of the personal data (driver attributes 420 in FIG. 4) to determine an impact of personal data on a vehicle efficiency of vehicle 602 (step 630). A predicted parameter may be one of personal fuel efficiencies 270. A user-specific parameter may be one of fuel economy 272 and carbon footprint 274 in FIG. 2.

Personal fuel efficiency program 220 can store a number of predictions and related data for validation and feedback to a learning model (step 632). Personal fuel efficiency program 220 can provide a personal fuel efficiency to a fleet optimization engine (step 640), display the predicted attributes (step 642), or provide the personal fuel efficiency to a recommendation engine (step 646). The fleet optimization engine can be fleet optimization engine 238 in FIG. 2. The recommendation engine can be recommendation engine 240 in FIG. 2. The recommendation engine can provide a recommendation such as one of recommendations 244 in FIG. 2. The recommendation can comprise recommended changes to improve fuel economy and carbon footprint of vehicle 602. For example, if the driver whose personal driving data in driver attributes 420 in FIG. 4 shows that the driver brakes hard while driving in the city with an effect on fuel economy, such a recommendation can be to tune the brakes of vehicle 602.

With reference now to FIG. 7, a block diagram of a data processing system, a user device, and a particular vehicle with a window display and a vehicle pricing sticker is depicted in accordance with an illustrative embodiment. System 700 comprises particular vehicle 702, user device 740, and data processing system 200. Particular vehicle 702 can be a vehicle on display in a showroom. In an illustrative embodiment, particular vehicle 702 can be a pre-owned vehicle on display in a pre-owned car lot. Particular vehicle 702 can comprise window display 720, vehicle pricing sticker 710, and application connection 730. Application connection 730 links particular vehicle 702 to user device 740 and data processing system 200. In an illustrative embodiment, user device 740 can be a cell phone of a user. In another illustrative embodiment, user device 740 may be a personal computing device. In an illustrative example, window display 720 can be an electronic display that, upon connecting to user device 740, displays make and model 722 of particular vehicle 702 and a personal fuel efficiency of “24 mpg” 724. Vehicle pricing sticker 710 is provided by a vehicle manufacturer and comprises make and model 712 and displays, in this particular example, “21 mpg” 714 for fuel economy. Window display 720 and display 742 of user device 740 provide a personal fuel efficiency that has been determined based on data from data processing system 200. The difference between the personal fuel efficiency of “24 mpg” 724 of window display 720 and vehicle pricing sticker 710 stating the fuel economy of “21 mpg” 714 for particular vehicle 702 is determined by personal fuel efficiency program 220 in FIG. 2. Likewise, the difference between the personal fuel efficiency of “24 mpg” 746 of display 742 in user device 742 and vehicle pricing sticker 710 stating the fuel economy of “21 mpg” 714 for particular vehicle 702 is determined by personal fuel efficiency program 220 in FIG. 2. In an illustrative embodiment, “24 mpg” 724 and “24 mpg” 746 can be fuel economy 272 in personal fuel efficiencies 270 in FIG. 2.

With reference to FIG. 8, a pictorial representation of a user obtaining a personal fuel efficiency for a particular vehicle of interest using a cellphone, a window display, and a vehicle pricing sticker on the particular vehicle of interest is depicted in accordance with an illustrative embodiment. System 800 comprises vehicle of interest 810 and user 820. Vehicle of interest 810 comprises window display 830 and pricing sticker 840. Pricing sticker 840, which is prepared by the manufacturer, states that a fuel economy that can be achieved is twenty-one miles per gallon (see enlarged detail view 842). In another embodiment, pricing sticker 840 can be modified to contain a thin display so that pricing sticker 840 can function in a similar manner to window display 830 and display a personal fuel efficiency along with a manufacturer's fuel economy. In the alternate embodiment, pricing sticker 840 can display a manufacturer's statement of expected fuel economy in print and also display a personal fuel efficiency rating on a thin electronic display incorporated into pricing sticker 840 or affixed to pricing sticker 840. User 820 has cell phone 822. Both cell phone 822 and window display 830 are connected to a data processing system such as data processing system 200 in FIG. 2 by a network such as network 102 in FIG. 1. In an illustrative embodiment, when cell phone 822 belonging to user 820 comes within range of vehicle of interest 810, both cell phone 822 and window display 830 can state that user 820 will achieve twenty-four miles per gallon when driving vehicle of interest 810 (see enlarged detail view 824 for cell phone 822 and enlarged detail view 832 for window display 830). In another illustrative embodiment, window display 830 can have a bar code so that a system participant, such as user 820, can scan the bar code with cell phone 822 and receive a personal fuel efficiency for vehicle of interest 810. In an illustrative embodiment, a second user (not shown) can approach vehicle of interest 810, and based on the second user's personal driving history, receive a different value for fuel economy than the first user. The second user can receive a different value for fuel economy because personal fuel efficiency program 220 in FIG. 2 determines a different value based on the second user's driver attribute data in driver attributes 420 in FIG. 4.

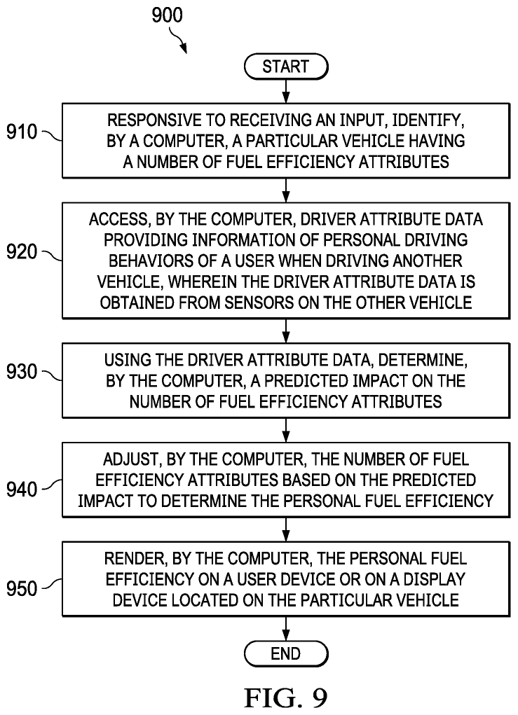

With reference now to FIG. 9, a flowchart illustrating a process for determining and displaying a personal fuel efficiency for a particular vehicle of interest to a user is shown in accordance with an illustrative embodiment. The process shown in FIG. 9 can be implemented in a computer, such as, for example, server 106 in FIG. 1 or data processing system 200 in FIG. 2. Process 900 may begin with, responsive to receiving an input, identifying, by a computer, a particular vehicle having a number of fuel efficiency attributes (step 910). The particular vehicle can be one of particular vehicle 520 in FIG. 5, vehicle 602 in FIG. 6, particular vehicle 702 in FIG. 7, and vehicle of interest 810 in FIG. 8. Driver attribute data, providing information of personal driving behaviors of a user when driving another vehicle, is accessed by the computer (step 920). The driver attribute data can be obtained from sensors on the other vehicle such as manufacturer sensors 542 and additional sensors 544 in vehicles driven by user 540 in FIG. 5. The driver attribute data can include a personal driving record, routes, and a location from database 610 in step 626 in FIG. 6. Using the driver attribute data, the computer determines a predicted impact on the number of fuel efficiency attributes (step 930). The computer adjusts the number of fuel efficiency attributes based on the predicted impact to determine the personal fuel efficiency (step 940). The computer renders the personal fuel efficiency on a user device or on a display device located on the particular vehicle (step 950). The user device can be user device 740 in FIG. 7. The user device can be cell phone 822 in FIG. 8. Afterwards, process 900 terminates.

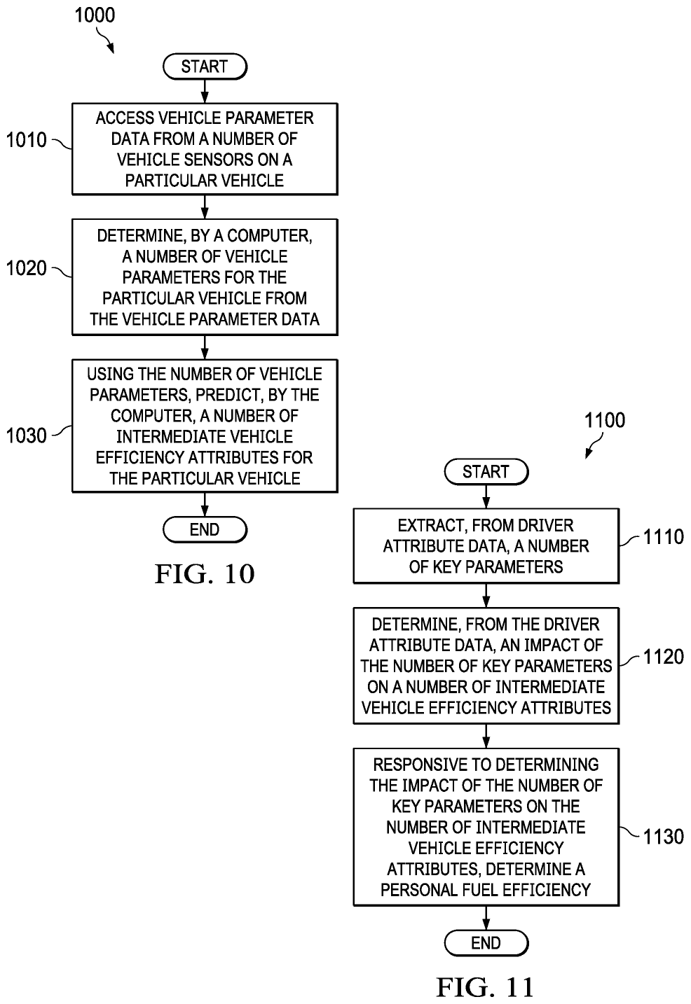

With reference now to FIG. 10, a flowchart illustrating a process for determining a personal fuel efficiency for a particular vehicle and a particular user is shown in accordance with an illustrative embodiment. The process shown in FIG. 10 can be implemented in a computer, such as, for example, server 106 in FIG. 1 or data processing system 200 in FIG. 2. Process 1000 begins. Vehicle parameter data from a number of vehicle sensors on a particular vehicle is accessed (step 1010). A computer determines a number of vehicle parameters for the particular vehicle from the parameter data (step 1020). The computer, using the number of vehicle parameters, predicts a number of intermediate vehicle efficiency attributes for the particular vehicle (step 1030). The number of sensors can be manufacturer sensors 522 in particular vehicle 520 in FIG. 5. Afterwards, process 1000 terminates.

With reference now to FIG. 11, a flowchart illustrating a process for determining a personal fuel efficiency is depicted in accordance with an illustrative embodiment. The process shown in FIG. 11 can be implemented in a computer, such as, for example, server 106 in FIG. 1 or data processing system 200 in FIG. 2. Process 1100 begins. A number of key parameters are extracted from driver attribute data (step 1110). The driver attribute data may be from one or more of manufacturer sensors 542 and additional sensors 544 in vehicles driven by user 540 in FIG. 5. An impact of the number of key parameters on a number of intermediate vehicle efficiency attributes is determined from the driver attribute data (step 1120). Responsive to determining the impact of the number of key parameters on the number of intermediate vehicle efficiency attributes, a personal fuel efficiency is determined (step 1130). The determination of the impact can be performed by personal fuel efficiency program 220 in FIG. 2. The impact may be impact 292 in determination data 290 in FIG. 2. The intermediate vehicle attributes may be intermediate vehicle attributes 293 in determination data 290 in FIG. 2. Afterwards, process 1100 terminates.

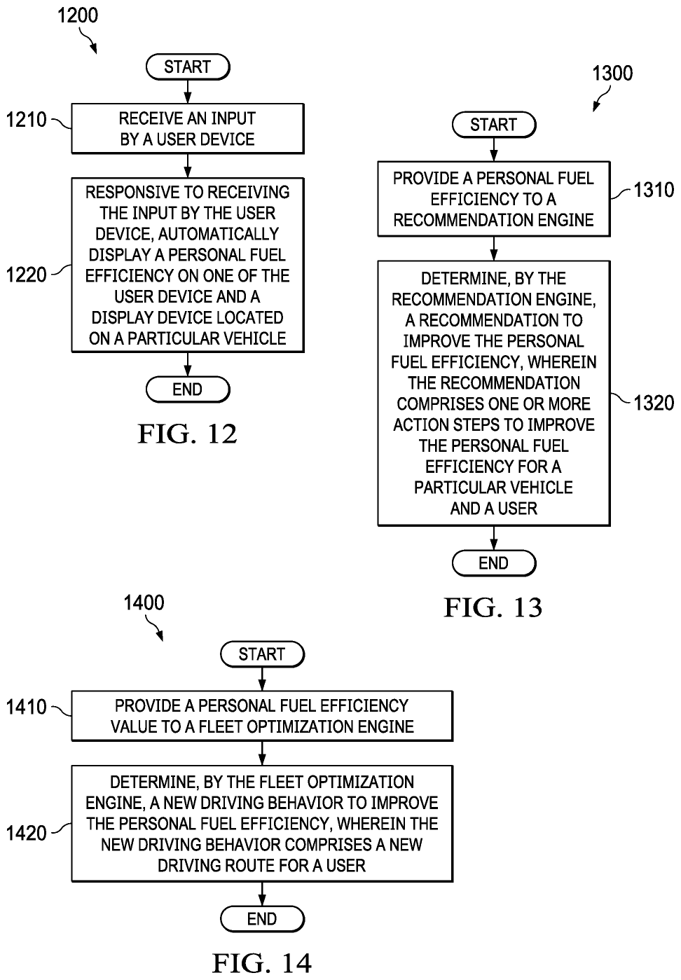

With reference now to FIG. 12, a flowchart illustrating a process for displaying a personal fuel efficiency rating for a particular vehicle and a user is shown in accordance with an illustrative embodiment. The process shown in FIG. 12 can be implemented in a computer, such as, for example, server 106 in FIG. 1 or data processing system 200 in FIG. 2. In addition, the process shown in FIG. 12 can be implemented in a system such as system 700 in FIG. 7 using application connection 730 to connect user device 740 to particular vehicle 702 and data processing system 200 in FIG. 2. Process 1200 begins. An input is received by a user device (step 1210). Responsive to receiving the input by the user device, a personal fuel efficiency is automatically displayed on one of the user device and the display device located on a particular vehicle (step 1220). The user device can be user device 740 in FIG. 7. The personal fuel efficiency can be displayed on display 742 of user device 740 in FIG. 7. The user device can be cell phone 822 in FIG. 8. The personal fuel efficiency can be displayed on one or more of window display 720 in FIG. 7. The personal fuel efficiency can be displayed on window display 830 in FIG. 8. Afterwards, process 1200 terminates.

With reference now to FIG. 13, a flowchart illustrating a process for using a personal fuel efficiency to determine a recommendation is shown in accordance with an illustrative embodiment. The process shown in FIG. 13 can be implemented in a computer, such as, for example, server 106 in FIG. 1 or data processing system 200 in FIG. 2. Process 1300 begins. A personal fuel efficiency is provided to a recommendation engine (step 1310). The recommendation engine can be recommendation engine 240 in FIG. 2. The recommendation engine determines a recommendation to improve the personal fuel efficiency, wherein the recommendation comprises one or more action steps to improve the personal fuel efficiency for a particular vehicle and a user (step 1310). The one or more action steps can be action steps 245 in recommendations 244 in FIG. 2. Afterwards, process 1300 terminates.

With reference now to FIG. 14, a flowchart illustrating a process for using a personal fuel efficiency to determine a new driving behavior is shown in accordance with an illustrative embodiment. The process shown in FIG. 14 can be implemented in a computer, such as, for example, server 106 in FIG. 1 or data processing system 200 in FIG. 2. Process 1400 begins. A personal fuel efficiency is provided to a fleet optimization engine (step 1410). The fleet optimization engine determines a new driving behavior to improve the personal fuel efficiency, wherein the new driving behavior comprises a new driving route for a user (step 1420). The new driving behavior can comprise new driving behavior 246 in FIG. 2. The new driving route can include a new driving route such as new driving route 247 in FIG. 2. Afterwards, process 1400 terminates.

Thus, illustrative embodiments of the present invention provide a computer-implemented method, computer system, and computer program product for predicting probable consequences of one or more activities corresponding to an event based on cognitive modeling and generating action step recommendations to eliminate or reduce impact of the probable consequences. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for displaying a personal fuel efficiency for a first vehicle of interest to a user, the computer-implemented method comprising:
responsive to receiving an input, identifying, by a computer, the first vehicle having a number of fuel efficiency attributes;
accessing, by the computer, driver attribute data providing information of personal driving behaviors of the user when driving a second vehicle, wherein the driver attribute data is obtained from a number of sensors on the second vehicle;
using the driver attribute data, determining by the computer, a predicted impact on the number of fuel efficiency attributes;
adjusting, by the computer, the number of fuel efficiency attributes based on the predicted impact to determine the personal fuel efficiency; and
rendering, by the computer, the personal fuel efficiency on a user device or on a display device located on the first vehicle.

2. The computer-implemented method of claim 1 further comprising:
accessing vehicle parameter data from a number of sensors on the first vehicle;
determining, by the computer, a number of vehicle parameters for the first vehicle from vehicle parameter data; and
using the number of vehicle parameters, predicting by the computer, a number of intermediate vehicle efficiency attributes for the first vehicle.

3. The computer-implemented method of claim 2 further comprising:
extracting from the driver attribute data, a number of key parameters;
determining an impact of the number of key parameters on the number of intermediate vehicle efficiency attributes for the first vehicle; and
responsive to determining the impact of the number of key parameters on the number of intermediate vehicle efficiency attributes, the personal fuel efficiency is determined.

4. The computer-implemented method of claim 1, wherein the sensors comprise manufacturer sensors and additional sensors.

5. The computer-implemented method of claim 2, wherein the vehicle parameter data is combined with crowdsourced data for vehicles of a same make and model as the first vehicle, wherein the crowdsourced data is a result of a crowdsourcing activity that is a type of participative online activity in which an entity proposes to a number of participants on an internet to undertake a task.

6. The computer-implemented method of claim 1 further comprising:
receiving the input by the user device; and
responsive to receiving the input by the user device, displaying the personal fuel efficiency on one of the user device and the display device located on the first vehicle.

7. The computer-implemented method of claim 1 further comprising:
providing the personal fuel efficiency to a recommendation engine; and
determining, by the recommendation engine, a recommendation to improve the personal fuel efficiency;
wherein the recommendation comprises one or more action steps to improve personal fuel efficiency for the first vehicle and the user.

8. The computer-implemented method of claim 1, further comprising:
providing the personal fuel efficiency to a fleet optimization engine; and
determining, by the fleet optimization engine, a new driving behavior to improve the personal fuel efficiency, wherein the new driving behavior comprises a new driving route for the user.

9. The computer-implemented method of claim 1, wherein the personal fuel efficiency is selected from at least one of a fuel economy value or a carbon footprint value.

10. A computer system for displaying a personal fuel efficiency for a first vehicle of interest to a user, the computer system comprising:
a bus system;
a storage device connected to the bus system, wherein the storage device stores program instructions; and
a processor connected to the bus system, wherein the processor executes the program instructions to: responsive to receiving an input, identify the first vehicle having a number of fuel efficiency attributes; access driver attribute data providing information of personal driving behaviors of the user when driving a second vehicle, wherein the driver attribute data is obtained from a number of sensors on the second vehicle; using the driver attribute data, determine a predicted impact on the number of fuel efficiency attributes; adjust the number of fuel efficiency attributes based on the predicted impact to determine the personal fuel efficiency; and render the personal fuel efficiency on a user device or on a display device located on the first vehicle.

11. The computer system of claim 10, wherein the processor further executes the program instructions to: access vehicle parameter data from the first vehicle; determine a number of vehicle parameters for the first vehicle from the vehicle parameter data; and using the number of vehicle parameters, predict a number of intermediate vehicle efficiency attributes for the first vehicle.

12. The computer system of claim 11, wherein the processor further executes the program instructions to: extract from the driver attribute data, a number of key parameters; determine an impact of the number of key parameters on the number of intermediate vehicle efficiency attributes for the first vehicle; and responsive to determining the impact of the number of key parameters on the number of intermediate vehicle efficiency attributes, the personal fuel efficiency is determined.

13. The computer system of claim 11, wherein the sensors comprise manufacturer sensors and additional sensors; and wherein the vehicle parameter data is combined with crowdsourced data for vehicles of a same make and model as the first vehicle, wherein the crowdsourced data is a result of a crowdsourcing activity that is a type of participative online activity in which an entity proposes to a number of participants on an internet to undertake a task.

14. The computer system of claim 10, wherein the processor further executes the program instructions to: receive the input by the user device; and responsive to receiving the input by the user device, display the personal fuel efficiency on one of the user device and the display device located on the first vehicle.

15. The computer system of claim 10, wherein the processor further executes the program instructions to: provide the personal fuel efficiency to a recommendation engine stored in the computer system; and determine, by the recommendation engine, a recommendation to improve the personal fuel efficiency, wherein the recommendation comprises one or more action steps to improve performance for the first vehicle and the user.

16. The computer system of claim 10, wherein the processor further executes the program instructions to: provide the personal fuel efficiency to a fleet optimization engine; and determine, by the fleet optimization engine, a new driving behavior to improve the personal fuel efficiency, wherein the new driving behavior comprises a new driving route for the user.

17. The computer system of claim 10, wherein the personal fuel efficiency is selected from at least one of a fuel economy value or a carbon footprint value.

18. A computer program product for displaying a personal fuel efficiency for a first vehicle of interest to a user, the computer program product comprising a computer-readable storage medium having program instructions embodied therewith, the program instructions executable by a computer to cause the computer to perform a method comprising:
responsive to receiving an input, identifying the first vehicle having a number of fuel efficiency attributes;
accessing driver attribute data providing information of personal driving behaviors of the user when driving a second vehicle, wherein the driver attribute data is obtained from a number of sensors on the second vehicle;
using the driver attribute data, determining a predicted impact on the number of fuel efficiency attributes;
adjusting the number of fuel efficiency attributes based on the predicted impact to determine the personal fuel efficiency; and
rendering, by the computer, the personal fuel efficiency on a user device or on a display device located on the first vehicle.

19. The computer program product of claim 18, wherein the program instructions executable by the computer to cause the computer to perform the method further comprising:
accessing vehicle parameter data from a number of sensors on the first vehicle;
determining a number of vehicle parameters for the particular vehicle from the vehicle parameter data; and
using the number of vehicle parameters, predicting a number of intermediate vehicle efficiency attributes for the first vehicle.

20. The computer program product of claim 19, wherein the program instructions executable by the computer to cause the computer to perform a method further comprising:
extracting from the driver attribute data, a number of key parameters;
determining an impact of the number of key parameters on the number of intermediate vehicle efficiency attributes for the first vehicle; and
responsive to determining the impact of the number of key parameters on the number of intermediate vehicle efficiency attributes, the personal fuel efficiency is determined.
